(19) United States
(12) Patent Application Publication
(10) Pub. No.: US 2009/0313277 A1
(43) Pub. Date: Dec. 17, 2009

(54) SYSTEM AND METHOD FOR 3-D MAP COMPRESSION AND INTERSECTION DETERMINATION

(76) Inventor: Michael RISSMAN, Bisbee, AZ (US)

Correspondence Address: MCGUIREWOODS, LLP, 1750 TYSONS BLVD, SUITE 1800, MCLEAN, VA, 22102, US

(21) Appl. No.: 12/482,135

(22) Filed: Jun. 10, 2009

Related U.S. Application Data
(60) Provisional application No. 61/061,776, filed on Jun. 16, 2008.

(51) Int. Cl. G06F 17/30

(52) U.S. Cl. 707/101; 707/E17.055

(57) ABSTRACT

A system and method is presented that provides for efficiently representing coordinate date of objects such as for buildings, excavations, pipelines, sewers, underground objects and the like. Also provided is a process for compressing representation of a coordinate system, for example, GPS coordinates, to minimize data requirements and to significantly increase overall efficiencies to determine if an existing object might overlap or intersect with a proposed new object. For example, the system and method of the invention may be suitable for use by utilities that have underground plant that requires awareness whether or not a proposed new construction might overlap with the plant.

This application claims benefit and priority to U.S. Provisional Patent application No. 61/061,776 filed Jun. 16, 2008 and entitled “SYSTEM AND METHOD FOR 3-D MAP COMPRESSION AND INTERSECTION DETERMINATION, the content of which is incorporated by reference herein.

### 1.0 FIELD OF INVENTION

The invention relates generally to a system for compressing map objects and determining whether two objects intersect and, more particularly, to a system and method for compressing the representation of objects in two or more dimensions, and for determining whether an intersection exists between the two objects based on the compressed mapping.

### 2.0 RELATED ART

When a new project is under consideration such as, for example, a new building, new construction, or a new pipeline, the company, person or utility involved often requires forehand knowledge whether or not the new project may conflict with existing objects, or other proposed objects (i.e., buildings, foundations, pipelines, sewers, power lines, communication lines and the like). The object may be any polygonal shaped structure or even a substantially circular shaped entity. A common situation is for detecting/identifying underground facilities in an excavation area.

Facility owners, such as electric, gas, water, cable, telephone utilities or companies, typically provide facility information to a call center. The call center may take information from builders, excavators, and the like, about a project under consideration, and the call center uses a Geographical Information System (GIS) to determine intersections between utility facilities and the proposed construction of excavation area. The GIS generally performs spatial reasoning to detect encroachments of objects one on the other. GIS examples include MapInfo from Pitney Bowes or a GIS system from ESRI (Environmental Systems Research Institute, Inc.). The GIS detects encroachments using a two-step process. Every object in the GIS database is stored with its bounding rectangle, the smallest rectangle that completely encloses the object. The GIS selects all objects whose bounding rectangles intersect with the bounding rectangle of the focus object (in the above example the excavation area). To determine which objects actually intersect, the GIS compares each candidate object to the focus object. To do so, the GIS typically represents the object as a large block of layered bytes, each layer dividing the layer above into 4 quadrants. To start, a flat projection of the globe is divided into 4 quarters each represented by a bit. The bit for each quadrant in which the object resides is set to ON. The next layer contains 16 bits, 4 for each quadrant in the first layer. A bit set to ON indicates the presence of the object in the sector, each representing 1/16 of the globe's surface.

The problem with this method is that each object usually requires a large data structure. The memory demands alone may be a detriment to users, consuming memory resources and making back-up and fail-over cumbersome. Furthermore, the GIS systems are expensive and thus put spatial reasoning out of reach of the small user. Finally, the bit-method of representing the object can be slow when evaluating candidates for encroachment.

To speed up encroachment detection and reduce memory, some GIS's allow the user to trade accuracy for performance, in essence trimming the bottom layers of the bit-quadrant representation. Moreover, present GIS systems also fail to address three dimensional representations of objects.

To get around the GIS problems, some have tried representing objects as grids. Objects are represented as a set of grids of a particular size. A naming convention is used to identify the grid, perhaps a concatenation of the latitude and longitude of one of the corners of the grid. Pennsylvania One Call System (POCS) uses, as an example, the following convention: 422645-0772233sw01, which means a one-second grid with its southwest corner at 42.26.45 latitude and −77.22.33 longitude.

A facility is typically represented in a database table one grid per row. In order to determine what facilities might be under an excavation area, the area is represented as a set of grids. A query of the facility grids table indicates what facilities intersect with the excavation polygon, for example. However, a significant problem with this approach is that the facility grids table can be very large; for POCS, a typical size may be 18 million rows, or more. This makes the database difficult to maintain and substantially slows down computational performance during peak call times. Furthermore, the grids for each excavation area usually need to be saved, consuming more computational time and people time, and take up considerable storage space (which all have to be maintained and backed-up).

### SUMMARY OF THE INVENTION

The system and method of the invention overcomes the shortcomings in the existing art and provides a system and method that includes describing or compressing a coordinate system that significantly reduces computer resource space and processing time for more reliably determining whether or not an intersection of at least two objects might exist. The determination may be based on multiple dimensions. Computer performance may not expand exponentially with the size of the excavation area or the number of facilities or objects that must be tested for intersection.

In one aspect, a computer-implemented method for determining overlap of objects is provided. The computer-implemented method includes compressing a first matrix representation of a first object by creating a first set of indicia to represent at least one run in relation to a first known origin in a row and column notation, the first matrix representation maintained in an electronic database, compressing a second matrix representation of a second object by creating a second set of indicia to represent at least one run in relation to a second known origin in a row and column notation, the second matrix representation maintained in an electronic database, comparing the first set of indicia with the second set of indicia to determine whether at least a portion of the first object overlaps with the second object and outputting at least one of: an indication that at least a portion of the first object overlaps with at least a portion of the second object and an indication that no overlap of the first object and the second object exists.

In another aspect, a system for determining overlap of objects is provided. The system includes a compressing component executing in a computer platform configured to compress a first matrix representation of a first object by creating a first set of indicia to represent at least one run in relation to a first known origin in a row and column notation and configured to compress a second matrix representing a second object by creating a second set of indicia to represent at least one run in relation to a second known origin in a row and column notation, a comparing component executing in the computer platform configured to compare the first set of indicia with the second set of indicia to determine whether at least a portion of the first object overlaps with the second object, and an output component configured to output at least one of: an indication that at least a portion of the first object overlaps with the second object and an indication that no overlap exists.

### BRIEF DESCRIPTIONS OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In the drawings:

FIG. 1 is a block diagram of an embodiment of a system, configured according to principles of the invention; and

FIG. 2 is a flow diagram showing exemplary steps for performing a process in accordance with principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatuses, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention. An object is generally defined as any shape that can be drawn either as a point or an area (or volume) defined by a set of connected points.

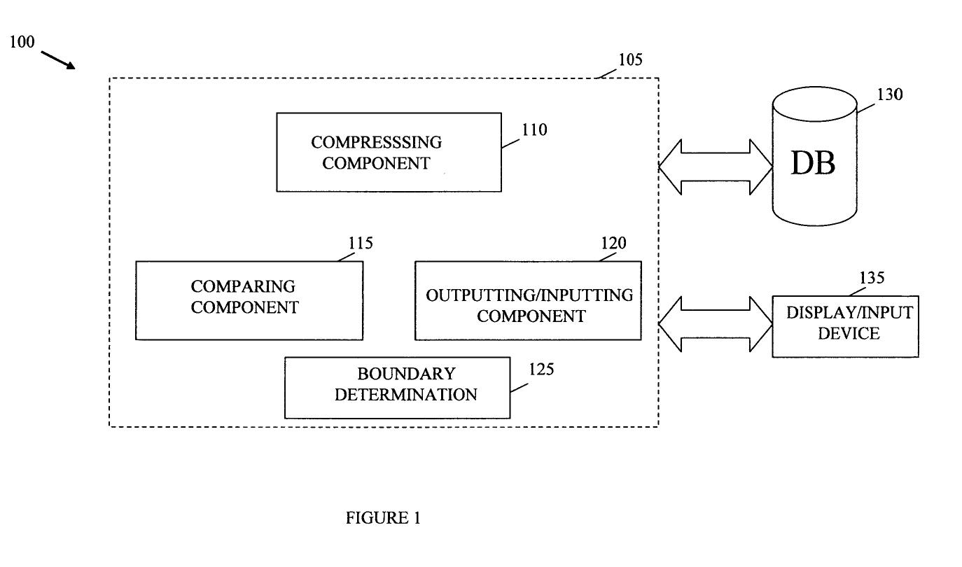

FIG. 1 is a block diagram of an embodiment of a system, configured according to principles of the invention. The system 100 includes a computing platform 105 having a processor, memory and input/output connectivity to receive and convey information from and to a user. Outputting/Inputting component 120 may be provided to convey output and or results, and/or receive user input. Alternatively, the computing platform may be a distributed type platform such as found in client-server type architecture with one or more of the computing platform components and functions described herein distributed among different platforms. The system 100 may include the computing platform 105, and a compressing component 110 configured to compress representations of objects according to principles of the invention, described more fully below. The compressing component may reduce storage requirements for storing representations of the objects by compressing the data representing the objects according to principles of the invention. This may significantly transform the storage space utilization within a database. The objects may include, for example, buildings, excavations, pipes, sewers, power lines, communication lines or the like. As used herein, an object may be considered principally as being two or three-dimensional polygons, but circular-type objects are also contemplated.

A comparing component 115 may be included as part of the system 100 that is configured to compare a plurality of objects using the compressed representations of the objects to determine if any portion of the objects overlap or intersect based on the compressed representations, described more fully below. If any portion of the objects is deemed to overlap or intersect, then an indication whether or not they intersect may be output on display/input device 135. The display/input device may be separate devices (display device and an input device) but is shown as one device in FIG. 1, for simplicity. The system 100 may further include a boundary determination component 125 to determine a minimum sized rectangle that bounds an object under consideration, according to principles of the invention, and as described more fully below. A database 130 may be included for storing and retrieving compressed representations of the objects, which in some embodiments may be a library of objects such as associated with utility companies or governmental bodies (e.g., cities or states). The system 100 also includes necessary inter-component communication structure (partially shown), for example, software inter-process communications and/or hardware interconnectivity, to facilitate coordination among the system components.

A polygon representative of an object, perhaps, for example, a building or an excavation area (which in some applications might be a space/void) may be modeled by a matrix system which may include a grid system and/or a pixel system. The matrix may be defined in any coordinate terms that are as granular or broad as necessary to accomplish the intended applied purpose, with the precision as desired. For ease of explanation, a grid system is primarily used herein to describe the principles of the invention, but could equally as well be described using a pixel system. The corresponding physical orientations may be mapped to physical locations, perhaps using a global positioning system (GPS) type location system, or other coordinate system (e.g., inches, feet, meters, or portions thereof, and the like.

Aspects of the invention include compression algorithms for use on a matrix in 2-dimensions (or more). The examples used herein utilize two dimensions for simplicity of description but the principles of the invention are just as applicable to three or more dimensions.

Consider the 8-by-8 matrix of Table 1A. The rows (horizontal orientation—latitude on a flat projection) are numbered 0 through 7 as are the columns (vertical orientation—longitude on a flat projection). The rows are referred to as R0 through R7 and the columns as C0 through C7. A cell of the matrix is named in reference to an origin, in this example, its southwest corner (nearly any relative referencing scheme could be used). Thus, the cell with the X below is known as R2-C4. (Geographically each cell may represent an area of arbitrary degrees, minutes or seconds: for example grids of 1 second by 1 second.) Chuck, I forgot we discussed this below.

TABLE 1A

| | | | | | | | | |
|---|---|---|---|---|---|---|---|---|
| | | | | | | | | R7 |
| | | | | | | | | R6 |
| | | | | | | | | R5 |
| | | | | | | | | R4 |
| | | | | | | | | R3 |
| | | | | X | | | | R2 |
| | | | | | | | | R1 |
| | | | | | | | | R0 |
| C0 | C1 | C2 | C3 | C4 | C5 | C6 | C7 | |

One aspect of the invention includes representing sets of cells (such as Table 1A) in a database efficiently so that one can test what sets in the database intersect with a new set of cells. In practical use, this might be used to determine what items or objects already on a map (of a known size and shape) intersect with a newly drawn (or proposed) item or object (or conversely).

The process may be described generally in stages or general steps:
Representing the set for database storage.
Querying the database for candidate intersections.
Testing whether candidates intersect.

### Representing a Set of Grids

Table 1B shows an example of an object comprising about six cells; the cells are labeled X1 through X6. A cell represents presence of a portion of an object.

TABLE 1B

| | | | | | | | | |
|---|---|---|---|---|---|---|---|---|
| | | | | | | | | R7 |
| | | | | | | | | R6 |
| | | | | | | | | R5 |
| | | | | | | X2 | | R4 |
| | | | | | X4 | X3 | | R3 |
| | | | | X1 | X5 | X6 | | R2 |
| | | | | | | | | R1 |
| | | | | | | | | R0 |
| C0 | C1 | C2 | C3 | C4 | C5 | C6 | C7 | |

The six cells may be named by an exemplary convention as follows:
X1: R2-C4
X2: R4-C6
X3: R3-C6
X4: R3-C5
X5: R2-C5
X6: R2-C6

The six cells themselves may be derived explicitly by specification or implicitly from some other representation of the object such as a graphical representation or an outline. (For outline, an algorithm may be used to determine what pixels are inside a polygon). A “run” is a term indicating the number of cells in a row that are contiguous (one cell that is not contiguous with another cell is considered a run of length 1, two cells that are contiguous is a run length of 2, three cells that are contiguous is a run length of 3, and so forth). Cells that are not contiguous in one row, create at least two runs (more runs are possible). That is, a row may have many runs.

The output of a representation algorithm may include the following:
The object's minimum bounding rectangle—i.e., the smallest rectangle enclosing the object.
The compressed list of cells occupied by the object.
   The minimum bounding rectangle may be represented by four values:
MinRow
MaxRow
MinCol
MaxCol

### Sub Step 1:

First, process the list of grids to group the cells by row and determine the bounding rectangle. This function may be performed by the boundary determination component 125, or similar functional component. This path through the list may take theses steps for each cell:
Split the cell into its R and C values.
Compare R to the current MinRow and MaxRow.
Compare C to the current MinCol and MaxCol.
Add each C value to a list of values for the proper row.
   If this is the first cell in the row, create the list and store it.
   Fetch the list for the row R, and add the C value to R's list.
      By way of an example, initially, the data structures have the following values:

MinRow=Null

MaxRow=Null

MinCol=Null

MaxCol=Null

Row Collection:
Empty
   After the first time through the loop, the cell R2-C4 is identified. After it is processed, the data structures have the following values:

MinRow=2

MaxRow=2

MinCol=4

MaxCol=4

Row Collection:
R2: 4
   After all six iterations through the loop with the cells as ordered above, the data structures have the following values:

MinRow=2

MaxRow=4

MinCol=4

MaxCol=6

Row Collection
R2: 4, 5, 6
R3: 6, 5
R4: 6

### Sub Step 2

The process builds the compressed representation (e.g., using compressing component 110) for efficient storage and efficient analysis, described more below. The compression for the sample object of table 1B is 0-3|1-2|2-1. The vertical bars separate the rows, and m-n means n consecutive cells starting in column m. Rows are counted from (relative to) MinRow. So “0-3” refers to the cells R2-C4, R2-C5, and R2-C6. While the notation of “1-2” refers to R3-C5 and R3-C6, the notation “2-1” refers to R4-C6.

The process continues by iteratively looping through the Row collection starting with MinRow and continuing to MaxRow. For each row's column list:
Append a “|” to the output for all but the first row.
Sort the columns in ascending order.
Set the left hand number of the run (m in m-n) and count the consecutive columns to get n.
Append the resulting m-n.
   The process as described also handles the following conditions:
Rows with no cells
Rows with non-contiguous cells

To illustrate these conditions, some cells (X7, X8 and X9) have been added to the example object, as now shown in TABLE 1C, making the new list of cells:
X1: R2-C4
X2: R4-C6
X3: R3-C6
X4: R3-C5
X5: R2-C5
X6: R2-C6
X7: R6-C4
X8: R6-C5
X9: R4-C4

TABLE 1C

| | | | | | | | | |
|---|---|---|---|---|---|---|---|---|
| | | | | | | | | R7 |
| | | | | X7 | X8 | | | R6 |
| | | | | | | | | R5 |
| | | | | X9 | | X2 | | R4 |
| | | | | | X4 | X3 | | R3 |
| | | | | X1 | X5 | X6 | | R2 |
| | | | | | | | | R1 |
| | | | | | | | | R0 |
| C0 | C1 | C2 | C3 | C4 | C5 | C6 | C7 | |

Note that the Sub Step 1 process, without change, deals appropriately with this situation. The addition of the Row 6 cells changes the MaxRow from 4 to 6.

MinRow=2

MaxRow=6

MinCol=4

MaxCol=6

And the row lists include:

Row Collection
R2: 4, 5, 6
R3: 6, 5
R4: 6, 4
R6: 4, 5

The compression representation for this object is now: 0-3|1-2|0-1, 2-1|0-0|0-2. The new additions being: “0-1, 2-1” and “0-0.” The first (0-1, 2-1) indicates two runs of cells in the row. The second indicates a row with no cells (0-0).

Here are the enhancements to the algorithm for the second sub step:
Append a “|” to the output for all but the first row
If there is no list for the row, append 0-0
Sort the columns in ascending order
Set the left hand number of the run (m in m-n) and count the consecutive columns to get n. If there is a gap in the columns, start a new run. Separate the runs with a comma.
Append the m-n, m-n.
   It is also possible to reconstruct the cells referred to by a compression string as long as MinRow and MinCol are known.
   Decompression proceeds as follows:

Split the compression string into an array of rows by breaking the string at the vertical bars. Set the current row to MinRow (2, from the previous example)

For each entry in the array:
If the representation is 0-0 then skip the row (it has no cells), else,
Set the row name to R followed by the current row (R2)
Split the runs (n-m at the commas). For each run:
   Set the current column to the n value
   Loop m times
      Form the column name C followed by the current column C4 for example
      Output the cell name by concatenating row name—column name R2-C4 for example
      Increment the current column
         Increment the current row and loop to the next item in the row array.

The ability to reconstruct cell names may be important to applications that may want to compress the object “being drawn” and represent the objects “already on the map” in a table of cell names.

### Finding Intersecting Objects

Finding objects “on the map” (an “existing” object) that intersect with a “newly drawn object,” (a “candidate” object) may include selecting candidates from a table containing all the known objects (those on the map) with the new drawn object. Finding intersections may be performed by the comparing component 115, for example. (Although the example uses terms like “existing” object and “candidate” objects, these concepts also contemplate objects that may be purely proposed or virtual). Assume that all the known objects are stored in a table (or database) with the following sort of schema:
MinRow
MaxRow
MinCol
MaxCol
Compression
Bookkeeping information identifying the object (owner, type and/or identifying indicia such as location and orientation to establish an exact physical location, etc.)
   Such a table might have as many as a million such entries, or more, but is about two orders of magnitude improvement on the space required to save all the cells themselves in the table.

Even though testing two compressions for intersection may be generally efficient, expending processing time to test every item in the table may also be avoided. This avoidance is related to the concept of bounding rectangles. In order for two objects to intersect, their bounding rectangles must overlap.

Candidates for intersection may be identified with a single query. For the nine cell object above (i.e, Table 1C) the bounding rectangle may be defined as:
MinRow=2
MaxRow=6
MinCol=4
MaxCol=˜6
   Still referring to table 1C, the candidates are those where:

### Condition 1:

((((MinCol<=4 AND maxCol>=4) OR
(MinCol>=4 AND MinCol<=6))
AND ((MinRow<=2 AND MaxRow>=2)
OR (MinRow>=2 AND MinRow<=6)))

### Condition 2:

OR (MinCol<=4 AND MaxCol>=6 AND MinRow<=2
AND MaxRow>=6))
   Condition 1 handles the case where one of the corners of the bounding rectangle of the candidate is inside the bounding rectangle of the drawn object. Condition 2 handles the case where the bounding rectangle of the candidate totally contains the bounding rectangle of the drawn object.

### Evaluating Candidates

The candidate query delivers all the entries in the table that potentially intersect with the drawn object, and may be performed by the comparing component 115, for example, or similar component. These are tested one at a time for intersection. The focus is on the compressions and involves shifting the compressions to account for differences in the bounding rectangle.

For each candidate:
a) Create an ordered row list of the candidate's row compressions by splitting the compression at the vertical bars.
b) Set the candidate's current row to its MinRow
c) Loop from the candidate's MinRow and MaxRow for each Row
   i. If the candidate's row compression is 0-0, skip the row
   ii. Else, test whether the target has anything in that row by checking the ordered row list created in step (a) above
   iii. If the target has something for the current row other than 0-0 compare the candidate's run to the target's run for that row (see below)

Two objects intersect if and only if a pair of row compressions (one pair for each object) for the same row overlaps. As soon as such a row is found, testing may optionally stop; or processing may continue if all intersections are desired. If no such row is found when all rows are exhausted, the two objects do not intersect.

A more detailed description of testing whether two row compressions overlap, is now provided. First, looking at the general case where both the candidate row and the target row have a single run. To test overlap in a row:

Add the MinCol of the candidate to the m value to get the candidate runStart.

Add the MinCol of the target to the m value to get the target runStart.

Add n−1 to candidate runStart to get candidate runEnd.

Add n−1 to the target runStart to get the target RunEnd.

For the runs to overlap one of the following test conditions must be true:
Test 1: Candidate runStart>=target runStart and candidate runStart<=target runEnd.
Test 2: Candidate runEnd>=target runStart and candidate runEnd<=target runStart.
Test 3: Candidate runStart<=target runStart and candidate runEnd>=target runEnd.
   If one or both of the corresponding rows have multiple runs (separated by a comma), then the test is performed interweaving the tests of the runs but each individual test performed as above.

Following is an example comparing two objects to determine if an intersection exists. Table 2A represents a known target object “on the map.”

TABLE 2A

| | | | | | | | | |
|---|---|---|---|---|---|---|---|---|
| | | | | | | | | R7 |
| | | | | X | X | | | R6 |
| | | | | | | | | R5 |
| | | | | X | | X | | R4 |
| | | | | | X | X | | R3 |
| | | | | X | X | X | | R2 |
| | | | | | | | | R1 |
| | | | | | | | | R0 |
| C0 | C1 | C2 | C3 | C4 | C5 | C6 | C7 | |

And, Table 2B represents an object as a candidate:

TABLE 2B

| | | | | | | | | |
|---|---|---|---|---|---|---|---|---|
| | | | | | | | | R7 |
| | | | X | X | | | | R6 |
| | | | X | X | | | | R5 |
| | | | | | | | | R4 |
| | | | | | | | | R3 |
| | | | | | | | | R2 |
| | | | | | | | | R1 |
| | | | | | | | | R0 |
| C0 | C1 | C2 | C3 | C4 | C5 | C6 | C7 | |

The new candidate object has the following in the database:

MinRow=5

MaxRow=6

MinCol=3

MaxCol=4

Compression: 3-2|3-2

Thus, the bounding rectangles intersect. Splitting the compression of the candidate into row lists, gives:
R5: 0-2
R6: 0-2
   The row list for the target item is:
R2: 0-3
R3: 1-2
R4: 0-1, 2-1
R5: 0-0
R6: 0-2

Processing through the candidate rows, the target has information for R5, but it is “0-0.” No cells in a row indicate there is no intersection in a row. The second row in the loop is R6. For the candidate, the “0-2” in that row represents columns 3 and 4. The “0-2” in the target represents columns 4 and 5. The two overlap because of Test 1, above. Note that without information about the minimum columns, there would be no way to evaluate the run 0-2.

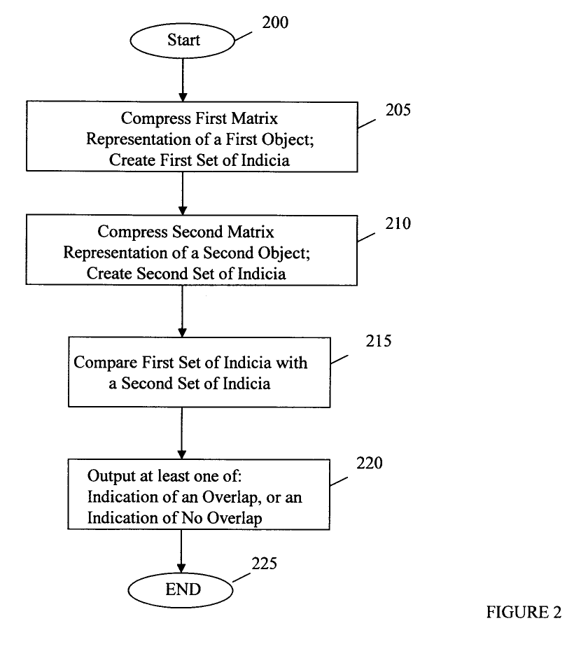

FIG. 2 is a flow diagram showing exemplary steps for performing a process in accordance with principles of the invention, starting at step 200. The description of one or more algorithms described previously in relation to Tables 1A-2B, for example, may be employed. The flow diagram(s) herein may also be a block diagram of the components for executing the corresponding steps thereof. The components may be software components or hardware components, or a combination of software and hardware, for performing the respective steps. The components may be a part of a computing platform suitable for performing the steps. The components may also be embedded as part of a computing platform and/or stored on a computer readable medium such as a memory, a CD, a DVD, a hard disk, and the like, and when read and executed, perform the respective steps.

At step 205, a first matrix representative of a first object may be compressed and a first set of indicia created representing the object in a compressed format. At step 210, a second matrix representative of a second object may be compressed and a second set of indicia created representative of the second object in a compressed format. At step 215, the first set of indicia is compared with the second set of indicia to determine whether the first object intersects (or overlaps) with the second object. At step 220, an indication of whether or not an overlap exists may be output to an appropriate user interface (such as a display) or, alternatively, provided to a software application for further processing. Moreover, storage of the compressed representations also may be stored in the database to reduce storage requirements for representation of the objects. At step 225, the process ends.

### Performance

The process described herein when implemented and executed on a computing platform as part of a computer algorithm scales very well. The only part of Step 1 that is not linear in the number of cells may be the step sorting the row lists. For square objects each list will contain m=SQRT(n) cells. Each sort is SQRT(m) log(m) steps. For a 10,000-cell object, there might be 100 rows each taking approximately 660 operations to sort. That comes to a total of 66,000 operations to sort the cells for generating the compression. Worst case is an object one row high. For this case, the sort would take nearly twice as many operations, about 132,000. For most applications, a 10,000-cell object is a rather big object.

The sort need be performed only once for the target at hand. Each object in the table containing the candidate may be sorted once when they are added to the table. The query to locate the candidates is invariant with the size of the object at hand and utilizes integer fields, generally inexpensive to index.

The candidate evaluation is typically linear with the number of rows in the candidate being compared to the target (can be improved to loop through whichever has the fewer rows—the target or the candidate). The number of runs in a row is usually 1.

Preliminary tests indicate that the algorithm finds intersecting objects in fractions of a second, using orders of magnitude less memory than either the brute force database approach or GIS approaches. (The brute force database approach involves saving one cell per table row. In one test compression reduced the size of the table from 18 million rows to 22,000 rows each row only slightly larger.

The process and system of the invention works on both display pixels and geographical grids. It can easily be extended to 3-dimensions by using bounding cubes and dividing the Z axis into planes, each being a 2-D compression as described above. The process may proceed to determine overlaps in each axis (x, y, and z).

### Alternate Description

In another embodiment, the principles of the invention may be described in a different manner, as follows.

Any polygon can be considered as having a bounding rectangle derivable either from a list of points or from a list of grids. The bounding rectangle is found by finding the minimum and maximum values on each axis, latitude and longitude. For clarity, the points might be named:
minLatSouth
maxLatNorth
minLonWest
maxLonEast
   All four of these points may be used when retrieving compressions for comparison to the compression of the object at hand, for example an excavation area. Finding these four points is linear with the number of grids. No matter what order the grids might be produced.

Assuming the following bounding rectangle, each grid contained in the object at hand is marked with an x.

$$44.00 .05 , \begin{matrix}- 77.00 .44 & 44.00 .05 , 77.00 .00\end{matrix}$$

$$\begin{matrix} & & x & & \\ & x & x & x & \\ x & x & x & x & x \\ x & x & x & x & \\ x & x & x & x & x \\ x & x & & & x\end{matrix}$$

$$44.00 .00 , \begin{matrix}- 77.00 .04 & 44.00 .00 , 77.00 .00\end{matrix}$$

minLatSouth=44.00.00
maxLatNorth=44.00.05
minLonWest=−77.00.04
maxLonEast=−77.00.00
   To compress the grids, each row is treated separately, starting with the minimum latitude and proceeding northward for example (other orientations may be used such as columns with appropriate adjustment in the sequencing).

The processing steps of the process might include:
Create a hash object that will hold grids. Each bucket is named according to the latitude of the row, ranging from the minimum latitude to the maximum latitude.
Loop through the grids placing longitude value in the appropriate latitude bucket.
Loop through the bucket to sort the contents.
Create the run compression of the row: 3-12 indicates a run of 12 grids starting in the 4^{th} (0-based) longitude column. 3-12, 16-2 indicates that there are two runs in the row.
Concatenate the row compressions as a single string using 0-0 to signify a row with no grids.

The compression of the 21 grids comprising the object above is: 0-2, 4-1|0-5|0-4|0-5|1-3|2-1. (From the compression, one can get back a list of grids if necessary). The compressed string is always stored with its min and max values. The first row 0-2, 4-1 stands for the grids:
440000-0770004sw01
440000-0770003sw01
440000-0770000sw01

The grid in the top row is the 5^{th} row from the bottom: 440005, and the third column from the left: −770002 or the grid 440005-0770002sw01. Restoring grids from compressions is useful in a mixed system where compressed representations need to be compared to grid tables.

This process is a worse case scenario as O(nlogn) is the time needed to sort a rectangle 1 grid high and n grids wide. But the worst case can be avoided if one allows compression by the narrowest dimension with the first character indicating orientation. For a square object, the algorithm may be O(sqrt-n log sqrt-n). The compression for almost all objects is typically very efficient, reducing tens of thousands of grids to a string a few thousand characters long.

### Storing Compressions for Effective Retrieval

Each compressed representation of a facility may be stored in a table with the following rows:
MinLatSouth-integer
MaxLatNorth-integer
MinLonWest-integer
MaxLonEast-integer
Compression-string

A database might have order of magnitude 100,000 to a million such rows in a facilities table (replacing much more substantial storage like individual grids or graphical objects). A simple query suffices to determine which of the facilities might intersect with the object at hand.

The query is based on the relationship between bounding rectangles necessary (but not sufficient) for intersection. The query tests for the following situations:

At least one of the corners of the candidate is inside the object at hand

All four of the corners of the object at hand are inside the candidate

The SQL for the conditions may look like this:
((((minLonWest<=−800604 AND maxLonEast>=−800604) OR (minLonWest>=−800604 AND minLonWest<=−800504)) AND ((minLatSouth<=402618 AND maxLatNorth>=402618) OR (minLatSouth>=402618 AND minLatSouth<=402647)))
OR (minLatSouth<=402618 AND maxLatNorth>=402647 AND minLonWest<=−800604 AND maxLonEast>=−800504))

The top condition tests whether one of the corners of the potential facility's bounding rectangle is inside the bounding rectangle of the object at hand. The bottom condition determines whether the potential facility's bounding rectangle completely surrounds the bounding rectangle of the object at hand. The numbers are for the object at hand. The look up is fast, particularly when the four integer fields are indexed.

### Testing Whether Two Compressions Intersect

To determine whether two polygons intersect, the row and columnar offset between the point(s) defining one and the point(s) defining the other may be calculated. The alignment in one dimension determines what latitude (rows) to compare. The longitude dimension is used to adjust the range representation.

Load the compression of the object at hand into a hash structure, one compression for each latitude minimum to maximum.

For each candidate:
Split the compression into an array of rows, minimum to maximum.
Loop through the array incrementing a latitude “pointer” by one grid increment starting with minLatEast.
Use the hash table to determine whether the object at hand is in that latitude row. If it is,
   Adjust the run compression of the candidate to account for the difference between the minLonWest of the object at hand and the minLonWest of the candidate.
   Compare the adjusted range compression of the candidate to the range compression of the object at hand.

The comparisons may be linear with the number of runs that need to be compared. The cost of comparing two runs may be constant with the size of the runs (just doing a mathematical comparison of run end points). As soon as two runs are found to overlap, the process may be terminated; or if a determination of all overlaps is desired, the process may continue until all rows are examined.

A “worst case” from a processing point of view, may be when two objects with the same bounding rectangle, together filling the rectangle but not intersecting (imagine two objects with interlocking teeth like a bear trap). But such a configuration is not likely.

A more likely worst case would be the following Table 3. It takes n run comparisons where n is the number of latitude rows. In this exemplary case, n is four.

TABLE 3

| | | | | |
|---|---|---|---|---|
| X | X | X | X | Z |
| X | X | X | Z | Z |
| X | X | Z | Z | Z |
| X | Z | Z | Z | Z |

The processes of the invention may be implemented computer programming logic stored in a computer readable medium that may be read and executed by a suitable computing platform. The system may include a computer platform having a memory and processor to execute at least one software component configured to receive the coordinate data (e.g., data to represent an object having two or more dimensions) for a target object and/or candidate object. The system may also include a data compression software component (which might be implemented partially or entirely in hardware) to compress the coordinate data as described above, and an intersection determination software component (perhaps implemented wholly or in part in hardware) to determine whether two objects intersect (as described previously), a database system for storing the coordinate information (e.g., the compressed coordinate system) and optionally identification indicia, and a suitable user interface to receive input or user commands, and/or to output the results of the intersection determination.

In some embodiments, a server may be configured to maintain access to the compressed objects stored in a database (e.g., DB 130) and on request from a client to provide data representing those objects, and/or update the database based on data from the client. Moreover, the server may be configured to perform any or all of the comparing function (e.g., to include comparing component 115), compressing function (e.g., to include the compressing component 110) and/or the boundary determination function (e.g., to include the boundary determination component 125).

The system and method of compression, when performed according to principles described herein, may facilitate backup and distribution of databases containing graphical information. Organizations using traditional “blobs” to represent objects often find it difficult to back up their gigabytes of data. Compression, according to principles described herein, may reduce the size of the data sufficiently to facilitate effective back up. What's more the significant reduction in size may allow organizations to distribute updates to their graphical data in real time. Hence, transmit time may become very practicable. This may enhance the utility of the data and may save lives in some applications.

While the invention has been described in terms of embodiments, those skilled in the art will recognize that the invention can be practiced with modifications and in the spirit and scope of the appended claims.

What is claimed is:

1. A computer-implemented method for determining overlap of objects, the computer-implemented method comprising the steps of:
compressing a first matrix representation of a first object by creating a first set of indicia to represent at least one run in relation to a first known origin in a row and column notation, the first matrix representation maintained in an electronic database;
compressing a second matrix representation of a second object by creating a second set of indicia to represent at least one run in relation to a second known origin in a row and column notation, the second matrix representation maintained in the electronic database;
comparing the first set of indicia with the second set of indicia to determine whether at least a portion of the first object overlaps with the second object; and
outputting at least one of: an indication that at least a portion of the first object overlaps with at least a portion of the second object and an indication that no overlap of the first object and the second object exists.

2. The computer-implemented method of claim 1, wherein the first and second matrix is one of a grid system and a pixel system.

3. The computer-implemented method of claim 2, wherein the grid system is a map system.

4. The computer-implemented method of claim 2, wherein the grid system comprises a global positioning system.

5. The computer-implemented method of claim 1, further comprising determining a first boundary of the smallest rectangle that bounds the first object and a second boundary of the smallest rectangle that bounds the second object.

6. The computer-implemented method of claim 5, wherein the comparing step includes comparing the first boundary with the second boundary to determine an overlap.

7. The computer-implemented method of claim 1, wherein each matrix represents a multi-dimensional object.

8. The computer-implemented method of claim 1, wherein at least one of the first set of indicia and the second set of indicia comprises indicia that is representative of three dimensions.

9. The computer-implemented method of claim 8, wherein the comparing step determines whether at least a portion of the first object overlaps with the second object, an overlap by comparing the first set of indicia with the second set of indicia, wherein the first set of indicia and the second set of indicia includes one of: two dimensional data and three dimensional data.

10. The computer-implemented method of claim 1, wherein the step of compressing a first matrix representation comprises compressing a representation of any one of: a building, a sewer, a cable, a pipe, an excavation, a hole, a void, and a physical item.

11. The computer-implemented method of claim 1, wherein the step of compressing a second matrix representation comprises compressing a representation of any one of: a building, a sewer, a cable, a pipe, an excavation, a hole, a void, and a physical item.

12. The computer-implemented method of claim 1, wherein at least one of: the first object and second object is a virtual object.

13. The computer-implemented method of claim 1, wherein the first known origin and the second known origin are the same origin.

14. The computer-implemented method of claim 1, wherein each of the compressing steps reduce storage requirements in the database that represents the first object and the second object.

15. A system for determining overlap of objects, the system comprising:
a compressing component executing in a computer platform configured to compress a first matrix representation of a first object by creating a first set of indicia to represent at least one run in relation to a first origin in a row and column notation and configured to compress a second matrix representing of a second object by creating a second set of indicia to represent at least one run in relation to a second origin in a row and column notation;
a comparing component executing in the computer platform configured to compare the first set of indicia with the second set of indicia to determine whether at least a portion of the first object overlaps with the second object; and
an output component configured to output at least one of: an indication that at least a portion of the first object overlaps with the second object and an indication that no overlap exists.

16. The system of claim 15, wherein the first and second matrix is one of a grid system and a pixel system.

17. The system of claim 15, wherein the grid system is a map system.

18. The system of claim 15, wherein the grid system comprises a global positioning system.

19. The system of claim 15, further comprising a component configured to determine a first boundary of the smallest rectangle that bounds the first object and a second boundary of the smallest rectangle that bounds the second object.

20. The system of claim 19, wherein the comparing component compares the first boundary with the second boundary to determine an overlap.

21. The system of claim 15, wherein each matrix represents a multi-dimensional object.

22. The system of claim 15, wherein at least one of the first set of indicia and the second set of indicia comprises indicia that is representative of a three dimensional object.

23. The system of claim 15, wherein the comparing component is configured to determine whether at least a portion of the first object overlaps with the second object, an overlap determined by comparing the first set of indicia with the second set of indicia, wherein the first set of indicia and the second set of indicia include one of: two dimensional data and three dimensional data.

24. The system of claim 15, wherein the compressing component is configured to compress a representation of any one of: a building, a sewer, a cable, a pipe, an excavation, a hole, a void, and a physical item.

25. The system of claim 15, wherein at least one of: the first object and second object is a virtual object.

26. The system of claim 15, wherein the first origin and the second origin are the same origin.

27. The system of claim 15, wherein the compressing component reduces database storage by compressing a data representation of a first object and a data representation of the second object.

28. The system of claim 15, wherein the first matrix has at least one cell that represents presence or non-presence of the first object, and the run is defined as one non-contiguous cell or a plurality of contiguous cells representing a presence of the first object.

29. The system of claim 15, wherein the second matrix has at least one cell that represents a presence or non-presence of the second object, and the run is defined as one non-contiguous cell or a plurality of contiguous cells representing the presence of the second object.
